(19) United States
(12) Patent Application Publication
(10) Pub. No.: US 2026/0265566 A1
(43) Pub. Date: Sep. 10, 2026

(54) INK SET AND INKJET RECORDING METHOD

(71) Applicant: Makoto KURONUMA, Kanagawa (JP)

(72) Inventor: Makoto KURONUMA, Kanagawa (JP)

(21) Appl. No.: 19/546,539

(22) Filed: Feb. 23, 2026

(30) Foreign Application Priority Data
Mar. 5, 2025 (JP) 2025-034939

(51) Int. Cl. C09D 11/54; B41J 2/21; B41J 11/00; C08K 5/00; C09D 11/322; C09D 11/324

(52) U.S. Cl. CPC C09D 11/54; B41J 2/2114; B41J 11/0021; C08K 5/0058; C09D 11/322; C09D 11/324

(57) ABSTRACT

An ink set is provided that includes: a pretreatment liquid comprising an inorganic compound, glycerin (A), and a surfactant; and an ink comprising a pigment, a resin, and glycerin (B). An aqueous solution of the inorganic compound dissolved in water at 25° C. at a concentration of 5% by mass is 4 or more to 8 or less. An image formed with the ink set on a low-absorbent medium by inkjet discharge using an inkjet head of a line head type has a mass ratio of the resin to the pigment of 1.6 or more to 20 or less, and the image contains an organic compound having an isocyanate group as detected by pyrolysis gas chromatography-mass spectrometry.

### CROSS-REFERENCE TO RELATED APPLICATIONS

This patent application is based on and claims priority pursuant to 35 U.S.C. § 119(a) to Japanese Patent Application No. 2025-034939, filed on Mar. 5, 2025, in the Japan Patent Office, the entire disclosure of which is hereby incorporated by reference herein.

### BACKGROUND

### Technical Field

The present disclosure relates to an ink set and an inkjet recording method.

### Related Art

In recent years, inkjet recording systems have been widely used as commercial printing because of advantages such as variable printing and adaptability to a wide range of media. In particular, in commercial printing, a printer of a line head type is used to improve productivity.

Media used in commercial printing are roughly classified into plain paper and coated paper. The ink composition for ensuring the optical density (“OD”) on plain paper is different from the ink composition for ensuring the glossiness on coated paper. Therefore, it is very difficult to satisfy all characteristics such as color reproducibility of an image, rubbing resistance, durability, light resistance, drying properties of an image, character blurring (feathering), color boundary blurring (color bleeding), beading, double-sided printability, and discharge stability, and the ink to be used is selected in accordance with the characteristics that are prioritized depending on the use.

### SUMMARY

Embodiments of the present invention provide an ink that includes: a pretreatment liquid comprising an inorganic compound, glycerin (A), and a surfactant; and an ink comprising a pigment, a resin, and glycerin (B). An aqueous solution of the inorganic compound dissolved in water at 25° C. at a concentration of 5% by mass is 4 or more to 8 or less. An image formed with the ink set on a low-absorbent medium by inkjet discharge using an inkjet head of a line head type has a mass ratio of the resin to the pigment of 1.6 or more to 20 or less, and the image contains an organic compound having an isocyanate group as detected by pyrolysis gas chromatography-mass spectrometry.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a structure of a circulation mechanism of an individual liquid chamber in an inkjet recording apparatus according to an embodiment of the present invention; and

FIG. 2 is a schematic diagram illustrating a structure of an inkjet recording apparatus according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

Conventional printers of a line head type are inferior in the discharge stability during continuous discharge.

According to one aspect of the present invention (hereinafter, sometimes simply referred to as “the present embodiment”), an ink set is provided that can print an image with desirable image density and robustness on a low-absorbent medium and also has desirable discharge stability.

The ink set according to the present embodiment can sufficiently solve various concerns in the related art. More specifically, the ink set that can print an image having desirable image density and robustness on a low-absorbent medium and also has desirable discharge stability.

Hereinafter, embodiments of the present invention will be described in detail. Note that embodiments are not limited to the following embodiments, and various modifications can be made within the scope thereof.

### Ink Set

The ink set according to the present embodiment includes a pretreatment liquid and an ink and may include a posttreatment liquid and other components as appropriate.

### Pretreatment Liquid

The pretreatment liquid includes an inorganic compound, glycerin (A), and a surfactant, and may include other components (A) as appropriate.

### Inorganic Compound

An aqueous solution of the inorganic compound has a pH of 4 or more to 8 or less when the inorganic compound is dissolved in water at 25° C. at a concentration of 5% by mass with respect to the total amount of the water. In the present specification, “the aqueous solution obtained by dissolving the inorganic compound in water at 25° C. at a concentration of 5% by mass with respect to the total amount of water” may be referred to as an “inorganic compound aqueous solution” for convenience.

When the pH of the inorganic compound aqueous solution is 4 or more, the liquid contact property to metal members is improved, which is preferable.

When the pH of the inorganic compound aqueous solution is 8 or less, the aggregation speed of the ink is improved, which is preferable.

The method for measuring the pH of the inorganic compound aqueous solution is not particularly limited and can be suitably selected to suit to a particular application. For example, the pH can be measured with a pH-meter (HM-41X manufactured by DKK-TOA CORPORATION).

Specific examples of the inorganic compounds include, but are not limited to, magnesium sulfates (pH: 5.0 to 8.0), calcium nitrates (pH: 4.0 to 6.0), and calcium chlorides (pH: 7.0). Among these, magnesium sulfates and calcium nitrates are preferable and calcium nitrates are more preferable from the viewpoint of the desirable density and robustness of the obtained image.

The proportion of the inorganic compound in the pretreatment liquid is not particularly limited and can be suitably selected to suit to a particular application, but is preferably 10% or more by mass to 30% or less by mass, and more preferably 10% or more by mass to less than 20% by mass from the viewpoint of desirable image density.

When the proportion of the inorganic compound in the pretreatment liquid is 10% or more by mass, the aggregation property of the ink is improved, which is preferable.

When the proportion of the inorganic compound in the pretreatment liquid is 30% or less by mass, the discharge property of the pretreatment liquid is improved, which is preferable.

As the inorganic compound, an appropriately synthesized one may be used, or a commercially available product may be used. Specific examples of commercially available products of the inorganic compound include, but are not limited to, magnesium sulfates (manufactured by FUJIFILM Wako Pure Chemical Corporation), calcium nitrate tetrahydrates (manufactured by FUJIFILM Wako Pure Chemical Corporation), and calcium chlorides (manufactured by FUJIFILM Wako Pure Chemical Corporation) as trade names.

### Glycerin (A)

In the present specification, in order to clearly distinguish the glycerin included in the pretreatment liquid from the glycerin included in the ink described below, the glycerin included in the pretreatment liquid is referred to as “glycerin (A)”, and the glycerin included in the ink is referred to as “glycerin (B)”.

The proportion of the glycerin (A) in the pretreatment liquid is not particularly limited and can be suitably selected to suit to a particular application, but is preferably 5% or more by mass to 15% or less by mass.

When the proportion of the glycerin (A) in the pretreatment liquid is 5% or more by mass, the discharge stability is improved, which is preferable. When the proportion of the glycerin (A) in the pretreatment liquid is 15% or less by mass, the image robustness is improved, which is preferable.

As the glycerin (A), an appropriately synthesized one may be used, or a commercially available product may be used. Specific examples of commercially available products of the glycerin (A) include, but are not limited to, glycerin (manufactured by FUJIFILM Wako Pure Chemical Corporation) as a trade name.

### Surfactant

The surfactant is not particularly limited and can be suitably selected to suit to a particular application. Specific examples of the surfactants include, but are not limited to, silicone-based surfactants, fluorine-based surfactants, ampholytic surfactants, nonionic surfactants, and anionic surfactants. Among these, an ampholytic surfactant is preferable from the viewpoint of improvement in the discharge stability of the pretreatment liquid.

Each of these can be used alone or in combination with others.

### Silicone-Based Surfactant

The silicone-based surfactant is not particularly limited and can be suitably selected to suit to a particular application, but those that do not decompose even at a high pH (pH: 11 to 14) are preferable. Specific examples of the silicone-based surfactants that do not decompose even at the high pH (pH: 11 to 14) include, but are not limited to, side-chain-modified polydimethylsiloxanes, both-end-modified polydimethylsiloxanes, one-end-modified polydimethylsiloxanes, and side-chain-and-both-end-modified polydimethylsiloxanes. Among these, from the viewpoint of improvement in hydrophilicity and higher solubility in water, those having a polyoxyethylene group and a polyoxyethylene polyoxypropylene group as a modifying group are preferable.

As the silicone-based surfactant, a polyether-modified silicone-based surfactant can also be used. The polyether-modified silicone-based surfactants are not particularly limited and can be suitably selected to suit to a particular application. Specific examples of the polyether-modified silicone-based surfactants include, but are not limited to, a compound represented by the following formula (S-1) that is a dimethylpolysiloxane having a polyalkylene oxide structure on its side chain bonded to Si atom.

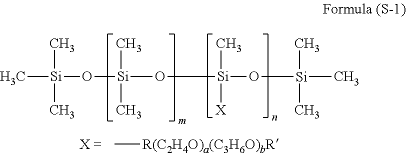

In the formula (S-1), m, n, a, and b each independently represent an integer. R represents an alkylene group, and R′ represents an alkyl group.

As the polyether-modified silicone-based surfactants, commercially available products can be used. Specific examples thereof include, but are not limited to, KF-618, KF-642, and KF-643 (all manufactured by Shin-Etsu Chemical Co., Ltd.), EMALEX-SS-5602, EMALEX-SS-1906EX (all manufactured by Nihon Emulsion Co., Ltd.), FZ-2105, FZ-2118, FZ-2154, FZ-2161, FZ-2162, FZ-2163, and FZ-2164 (all manufactured by Dow Corning Toray Silicone Co., Ltd.), BYK-33 and BYK-387 (both manufactured by BYK-Chemie GmbH), and TSF4440, TSF4452, and TSF4453 (all manufactured by Toshiba Silicones Co., Ltd.) as trade names.

### Fluorine-Based Surfactant

The fluorine-based surfactant is not particularly limited and can be suitably selected to suit to a particular application. However, from the viewpoint of low foamability, perfluoroalkyl sulfonic acid compounds, perfluoroalkyl carboxylic acid compounds, perfluoroalkyl phosphoric acid ester compounds, perfluoroalkyl ethylene oxide adducts, and polyoxyalkylene ether polymer compounds having a perfluoroalkyl ether group in a side chain are preferable.

Specific examples of the perfluoroalkyl sulfonic acid compounds include, but are not limited to, perfluoroalkyl sulfonic acids and perfluoroalkyl sulfonates.

Specific examples of the perfluoroalkyl carboxylic acid compounds include, but are not limited to, perfluoroalkyl carboxylic acids and perfluoroalkyl carboxylates.

Specific examples of the polyoxyalkylene ether polymer compounds having a perfluoroalkyl ether group on a side chain include, but are not limited to, a sulfate of a polyoxyalkylene ether polymer having a perfluoroalkyl ether group on its side chain, and a salt of a polyoxyalkylene ether polymer having a perfluoroalkyl ether group on its side chain.

Specific examples of the counter ions for these fluorine-based surfactants include, but are not limited to, Li, Na, K, NH₄, NH₃CH₂CH₂OH, NH₂(CH₂CH₂OH)₂, and NH(CH₂CH₂OH)₃.

Among these, fluorine-based surfactants represented by the following formulae (F-1) and (F-2) are preferable.

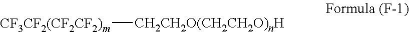

For the compound represented by the formula (F-1), m is preferably an integer of from 0 to 10, and n is an integer of from 0 to 40 in order to impart water solubility.

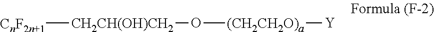

For the compound represented by the formula (F-2), Y is H, CₙF₂ₙ₊₁ (n is an integer of from 1 to 6), CH₂CH(OH)CH₂-CₘF₂ₘ₊₁ (m is an integer of from 4 to 6), or CₚH₂ₚ₊₁ (p is an integer of from 1 to 19), n is an integer of from 1 to 6, and a is an integer of from 4 to 14.

Preferably, the fluorine-based surfactant is a compound having 2 to 16 fluorine-substituted carbon atoms, more preferably a compound having 4 to 16 fluorine-substituted carbon atoms.

As the fluorine-based surfactant, an appropriately synthesized one may be used, or a commercially available product may be used. Specific examples of the commercially available product of the fluorine-based surfactant include, but are not limited to, SURFLON S-111, SURFLON S-112, SURFLON S-113, SURFLON S-121, SURFLON S-131, SURFLON S-132, SURFLON S-141, and SURFLON S-145 (all manufactured by AGC Inc.); FLUORAD FC-93, FLUORAD FC-95, FLUORAD FC-98, FLUORAD FC-129, FLUORAD FC-135, FLUORAD FC-170C, FLUORAD FC-430, and FLUORAD FC-431 (all manufactured by 3M Japan Limited); MEGAFACE F-470, MEGAFACE F-1405, and MEGAFACE F-474 (all manufactured by DIC Corporation); ZONYL TBS, FSP, FSA, FSN-100, FSN, FSO-100, FSO, FS-300, UR, CAPSTONE FS-30, CAPSTONE FS-31, CAPSTONE FS-3100, CAPSTONE FS-34, and CAPSTONE FS-35 (all manufactured by the Chemours Company); FT-110, FT-250, FT-251, FT-400S, FT-150, and FT-400SW (all manufactured by NEOS Co., Ltd.); POLYFOX PF-136A, POLYFOX PF-156A, POLYFOX PF-151N, POLYFOX PF-154, and POLYFOX PF-159 (manufactured by Omnova Solutions, Inc.), and UNIDYNE DSN-403N (manufactured by DAIKIN INDUSTRIES, LTD.) as trade names.

Among these fluorine-based surfactants, CAPSTONE FS-3100, CAPSTONE FS-34 and FS-300 manufactured by Chemours Company, FT-110, FT-250, FT-251, FT-400S, FT-150, and FT-400SW manufactured by NEOS Co., Ltd., POLYFOX PF-151N manufactured by Omnova Solutions, Inc., and UNIDYNE DSN-403N manufactured by DAIKIN INDUSTRIES, LTD. are particularly preferable from the viewpoint of significant improvements in desirable print quality, in particular, color developability, permeability to paper, wettability, and level dyeing property.

### Ampholytic Surfactant

The ampholytic surfactant is not particularly limited and can be suitably selected to suit to a particular application. Specific examples of the ampholytic surfactants include, but are not limited to, lauryl aminopropionates, lauryl dimethyl betaines, stearyl dimethyl betaines, lauryl dihydroxyethyl betaines, cocamidopropyl betaines, and N,N-dimethylalkylamine-N-oxides.

Among these, from the viewpoint of improvement in the discharge stability of the pretreatment liquid, cocamidopropyl betaines and N,N-dimethylalkylamine-N-oxides are preferable, and N,N-dimethylalkylamine-N-oxides are more preferable.

### Nonionic Surfactant

The nonionic surfactant is not particularly limited and can be suitably selected to suit to a particular application. Specific examples of the nonionic surfactants include, but are not limited to, polyoxyethylene alkyl phenyl ethers, polyoxyethylene alkyl esters, polyoxyethylene alkylamines, polyoxyethylene alkylamides, polyoxyethylene propylene block polymers, sorbitan fatty acid esters, polyoxyethylene sorbitan fatty acid esters, and ethylene oxide adducts of acetylene alcohol.

### Anionic Surfactant

The anionic surfactant is not particularly limited and can be suitably selected to suit to a particular application. Specific examples of the anionic surfactants include, but are not limited to, polyoxyethylene alkyl ether acetates, dodecylbenzene sulfonates, laurates, and salts of polyoxyethylene alkyl ether sulfates.

The proportion of the surfactant in the pretreatment liquid is not particularly limited and can be suitably selected to suit to a particular application, but is preferably 0.001% or more by mass to 5% or less by mass, and more preferably 0.05% or more by mass to 5% or less by mass from the viewpoint of desirable wettability and discharge stability and improved image quality.

As the surfactant, an appropriately synthesized one may be used, or a commercially available product may be used. Commercial products are readily available from, for example, BYK-Chemie GmbH, Shin-Etsu Chemical Co., Ltd., Dow Corning Toray Silicone Co., Ltd., Nihon Emulsion Co., Ltd., and Kyoeisha Chemical Co., Ltd.

### Other Components (A)

The other components (A) are not particularly limited and can be suitably selected to suit to a particular application. Specific examples thereof include, but are not limited to, flocculants other than the inorganic compound, organic solvents other than the glycerin (A), defoamers, antiseptic antifungal agents, corrosion inhibitors, pH adjusters, and water.

### Flocculant Other Than Inorganic Compound

The flocculant other than the inorganic compound is not particularly limited and can be suitably selected to suit to a particular application. Specific examples thereof include, but are not limited to, water-soluble cationic polymers, acids, and polyvalent metal salts.

Organic Solvent Other than Glycerin (A)

The organic solvent other than the glycerin (A) is not particularly limited and can be suitably selected to suit to a particular application. Specific examples thereof include, but are not limited to, water-soluble organic solvents. Specific examples of the water-soluble organic solvent include, but are not limited to, polyols, ethers such as polyol alkyl ethers and polyol aryl ethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and 3-methyl-1,3,5-pentanetriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ¿-caprolactam, and γ-butyrolactone; amides such as formamide, N-methylformamide, N,N-dimethylformamide, 3-methoxy-N,N-dimethyl propionamide, and 3-butoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate; and ethylene carbonate.

Among these water-soluble organic solvents, it is preferable to use organic solvents having a boiling point equal to or lower than 250° C., since the organic solvents not only function as a wetting agent, but also provide desirable drying properties.

Preferred examples of the water-soluble organic solvent further include, but are not limited to, polyol compounds having 8 or more carbon atoms and glycol ether compounds.

Specific examples of the polyol compounds having 8 or more carbon atoms include, but are not limited to, 2-ethyl-1,3-hexanediol and 2,2,4-trimethyl-1,3-pentanediol.

Specific examples of the glycol ether compounds include, but are not limited to, polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; and polyol aryl ethers such as ethylene glycol monophenyl ether and ethylene glycol monobenzyl ether.

The proportion of the organic solvent in the pretreatment liquid is not particularly limited and can be suitably selected to suit to a particular application, but is preferably 10% or more by mass to 60% or less by mass, and more preferably 20% or more by mass to 60% or less by mass from the viewpoint of the drying property and the discharge reliability of the pretreatment liquid.

### Defoamer

The surfactant can also be used as a defoamer.

The defoamer is not particularly limited and can be suitably selected to suit to a particular application. Specific examples of the defoamers include, but are not limited to, silicone defoamers, polyether defoamers, and fatty acid ester defoamers. Among these, silicone-based defoamers are preferable for their desirable defoaming ability.

Each of these can be used alone or in combination with others.

### Antiseptic Antifungal Agent

The antiseptic antifungal agent is not particularly limited and can be suitably selected to suit to a particular application. Specific examples thereof include, but are not limited to, 1,2-benzisothiazolin-3-one.

### Corrosion Inhibitor

The corrosion inhibitor is not particularly limited and can be suitably selected to suit to a particular application. Specific examples thereof include, but are not limited to, acid sulfites and sodium thiosulfates.

As the corrosion inhibitor, an appropriately synthesized one may be used, or a commercially available product may be used. Specific examples of the commercially available product of the corrosion inhibitor include, but are not limited to, PROXEL GXL (manufactured by Avecia Ltd.) as a trade name.

### pH Adjuster

The pH adjuster is not particularly limited and can be suitably selected to suit to a particular application as long as the pH can be adjusted to 7 or higher. Specific examples thereof include, but are not limited to, amines such as diethanolamine and triethanolamine.

### Water

The water is not particularly limited and can be suitably selected to suit to a particular application.

The proportion of the water in the pretreatment liquid is not particularly limited and can be suitably selected to suit to a particular application, but is preferably 10% or more by mass to 90% or less by mass, and more preferably 20% or more by mass to 60% or less by mass, from the viewpoint of the drying property and the discharge reliability of the pretreatment liquid.

Specific examples of a qualitative method and a quantitative method for various components contained in the pretreatment liquid and the other components (A) include, but are not limited to, gas chromatography-mass spectrometry (GC-MS). Specific examples of a measurement apparatus for GC-MS include, but are not limited to, GCMS-QP2020NX (manufactured by Shimadzu Corporation).

The water contained in the pretreatment liquid can be measured by a general method such as quantification of volatile components by GC-MS or mass change by simultaneous thermogravimetry-differential thermal analysis (TG-DTA).

The physical properties of the pretreatment liquid are not particularly limited and can be suitably selected to suit to a particular application. As an example, preferred viscosity, surface tension, and pH of the pretreatment liquid are described below.

The viscosity of the pretreatment liquid at 25° C. is preferably 4.0 mPa·s or more to 7.0 mPa·s or less from the viewpoint of improvements in the printing density and the character quality and the desirable discharge property. Here, the viscosity can be measured using, for example, a rotational viscometer (RE85L manufactured by Toki Sangyo Co., Ltd.).

Measurement can be performed under the measurement conditions of 25° C., the use of a standard cone rotor (1°34′×R24), a sample liquid volume of 1.2 mL, a rotation speed of 50 rpm, and three minutes.

The surface tension of the pretreatment liquid is preferably 35 mN/m or less and more preferably 32 mN/m or less at 25° C. from the viewpoint that the pretreatment liquid is suitably leveled on a low-absorbent medium and the drying time of the pretreatment liquid is shortened.

The pH of the pretreatment liquid is preferably from 7 to 12, more preferably from 8 to 11, from the viewpoint of preventing corrosion of metal materials in contact with the pretreatment liquid.

### Ink

The ink includes a pigment, a resin, and the glycerin (B), and may include other components (B) as appropriate.

### Pigment

The pigment is not particularly limited and can be suitably selected to suit to a particular application. For example, an inorganic pigment or an organic pigment may be used. Each of these can be used alone or in combination with others. Mixed crystals can also be used.

Specific examples of usable pigments include, but are not limited to, black pigments, yellow pigments, magenta pigments, cyan pigments, white pigments, green pigments, orange pigments, glossy color pigments (e.g., gold pigments and silver pigments), and metallic pigments.

Specific examples of inorganic pigments include, but are not limited to, titanium oxides, iron oxides, calcium carbonates, barium sulfates, aluminum hydroxides, barium yellow, cadmium red, chrome yellow, and carbon black produced by a known method, such as a contact method, a furnace method, and a thermal method.

Specific examples of organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye chelates and acid dye chelates), nitro pigments, nitroso pigments, and aniline black. Among these pigments, those having desirable affinity for solvents are preferred.

In addition, hollow resin particles and hollow inorganic particles can also be used as pigments.

Specific examples of the pigment include the following.

Specific examples of pigments for black include, but are not limited to: carbon blacks (C.I. Pigment Black 7) such as furnace black, lamp black, acetylene black, and channel black; metals such as copper, iron (C.I. Pigment Black 11), and titanium oxide; and organic pigments such as aniline black (C.I. Pigment Black 1).

Specific examples of the color pigments include, but are not limited to, C.I. Pigment Yellow 1, C.I. Pigment Yellow 3, C.I. Pigment Yellow 12, C.I. Pigment Yellow 13, C.I. Pigment Yellow 14, C.I. Pigment Yellow 17, C.I. Pigment Yellow 24, C.I. Pigment Yellow 34, C.I. Pigment Yellow 35, C.I. Pigment Yellow 37, C.I. Pigment Yellow 42 (yellow iron oxide), C.I. Pigment Yellow 53, C.I. Pigment Yellow 55, C.I. Pigment Yellow 74, C.I. Pigment Yellow 81, C.I. Pigment Yellow 83, C.I. Pigment Yellow 95, C.I. Pigment Yellow 97, C.I. Pigment Yellow 98, C.I. Pigment Yellow 100, C.I. Pigment Yellow 101, C.I. Pigment Yellow 104, C.I. Pigment Yellow 108, C.I. Pigment Yellow 109, C.I. Pigment Yellow 110, C.I. Pigment Yellow 117, C.I. Pigment Yellow 120, C.I. Pigment Yellow 138, C.I. Pigment Yellow 150, C.I. Pigment Yellow 153, C.I. Pigment Yellow 155, C.I. Pigment Yellow 180, C.I. Pigment Yellow 185, C.I. Pigment Yellow 213, C.I. Pigment Orange 5, C.I. Pigment Orange 13, C.I. Pigment Orange 16, C.I. Pigment Orange 17, C.I. Pigment Orange 36, C.I. Pigment Orange 43, C.I. Pigment Orange 51, C.I. Pigment Red 1, C.I. Pigment Red 2, C.I. Pigment Red 3, C.I. Pigment Red 4, C.I. Pigment Red 5, C.I. Pigment Red 17, C.I. Pigment Red 22, C.I. Pigment Red 23, C.I. Pigment Red 31, C.I. Pigment Red 38, C.I. Pigment Red 48:2, C.I. Pigment Red 48:3, C.I. Pigment Red 48:4, C.I. Pigment Red 49:1, C.I. Pigment Red 52:2, C.I. Pigment Red 53:1, C.I. Pigments Red 57:1 (Brilliant Carmine 6B), C.I. Pigment Red 60:1, C.I. Pigment Red 63:1, C.I. Pigment Red 63:2, C.I. Pigment Red 64:1, C.I. Pigment Red 81, C.I. Pigment Red 83, C.I. Pigment Red 88, C.I. Pigment Red 101 (red iron oxide), C.I. Pigment Red 104, C.I. Pigment Red 105, C.I. Pigment Red 106, C.I. Pigment Red 108 (Cadmium Red), C.I. Pigment Red 112, C.I. Pigment Red 114, C.I. Pigment Red 122 (quinacridone magenta), C.I. Pigment Red 123, C.I. Pigment Red 146, C.I. Pigment Red 149, C.I. Pigment Red 166, C.I. Pigment Red 168, C.I. Pigment Red 170, C.I. Pigment Red 172, C.I. Pigment Red 177, C.I. Pigment Red 178, C.I. Pigment Red 179, C.I. Pigment Red 184, C.I. Pigment Red 185, C.I. Pigment Red 190, C.I. Pigment Red 193, C.I. Pigment Red 202, C.I. Pigment Red 207, C.I. Pigment Red 208, C.I. Pigment Red 209, C.I. Pigment Red 213, C.I. Pigment Red 219, C.I. Pigment Red 224, C.I. Pigment Red 254, C.I. Pigment Red 264, C.I. Pigment Violet 1 (Rhodamine Lake), C.I. Pigment Violet 3, C.I. Pigment Violet 5:1, C.I. Pigment Violet 16, C.I. Pigment Violet 19, C.I. Pigment Violet 23, C.I. Pigment Violet 38, C.I. Pigment Blue 1, C.I. Pigment Blue 2, C.I. Pigment Blue 15 (Phthalocyanine Blue), C.I. Pigment Blue 15:1, C.I. Pigment Blue 15:2, C.I. Pigment Blue 15:3, C.I. Pigment Blue 15:4 (Phthalocyanine Blue), C.I. Pigment Blue 16, C.I. Pigment Blue 17:1, C.I. Pigment Blue 56, C.I. Pigment Blue 60, C.I. Pigment Blue 63, C.I. Pigment Green 1, C.I. Pigment Green 4, C.I. Pigment Green 7, C.I. Pigment Green 8, C.I. Pigment Green 10, C.I. Pigment Green 17, C.I. Pigment Green 18, and C.I. Pigment Green 36.

The pigment can be dispersed in the ink by any of the following methods: (1) introducing a hydrophilic functional group to the pigment to make the pigment self-dispersible; (2) covering the surface of the pigment with a resin; and (3) dispersing the pigment by a dispersant.

In the method (1) of introducing a hydrophilic functional group to the pigment to make the pigment self-dispersible, for example, a functional group such as sulfone group and carboxyl group may be introduced to the pigment (e.g., carbon) to make the pigment dispersible in water.

In the method (2) of covering the surface of the pigment with a resin, for example, the pigment may be incorporated in a microcapsule to make the pigment dispersible in water. The pigment in which the surface of the pigment is coated with the resin and is dispersed can be referred to as a resin-coated pigment. In a case where the pigment is dispersed by coating the surface of the pigment with the resin, not all of the pigment blended in the ink may be coated with the resin, and an uncoated pigment or a partially coated pigment may be dispersed in the ink within a range in which the effects of the present embodiment are not impaired.

In the method (3) of dispersing the pigment by a dispersant, known low-molecular dispersants and high-molecular dispersants, represented by surfactants, may be used. Any of anionic surfactants, cationic surfactants, ampholytic surfactants, and nonionic surfactants may be used as the dispersant depending on the property of the pigment. For example, a nonionic surfactant RT-100 manufactured by Takemoto Oil & Fat Co., Ltd. and sodium naphthalenesulfonate formalin condensate are preferably used as the dispersant. The dispersant can be used alone or in combination with others.

The ink can be obtained by mixing a pigment with other materials such as water and an organic solvent. The ink can also be obtained by, first, preparing a pigment dispersion by mixing a pigment with water, a dispersant, etc., and thereafter mixing the pigment dispersion with other materials such as water and an organic solvent.

The pigment dispersion can be obtained by mixing water, a pigment, a pigment dispersant, and other components, if any, to disperse the pigment, and adjusting the particle diameter of the pigment. Preferably, a disperser may be used for dispersing. Preferably, the pigment dispersion is subjected to filtration using a filter or a centrifugal separator to remove coarse particles, followed by degassing.

The particle diameter of the pigment in the pigment dispersion is not particularly limited, but the maximum frequency particle diameter is preferably 20 nm or more to 500 nm or less, and more preferably 20 nm or more to 150 nm or less, based on the number of pigments from the viewpoint that the dispersion stability of the pigment is desirable and the discharge stability and the image quality such as the image density are also high. The particle diameter of the pigment can be measured using a particle size analyzer (NANOTRAC WAVE II-UT151 manufactured by Microtrac MRB Corporation).

The proportion of the pigment in the pigment dispersion is not particularly limited and can be suitably selected to suit to a particular application, but is preferably 0.1% or more by mass to 50% or less by mass, and more preferably 0.1% or more by mass to 30% or less by mass, from the viewpoint of desirable discharge stability and enhanced image density.

The proportion of the pigment in the ink is preferably 0.1% or more by mass to 15% or less by mass and more preferably 1% or more by mass to 10% or less by mass from the viewpoint of improved image density and desirable fixability and discharge stability.

### Resin

The resin is not particularly limited and can be suitably selected to suit to a particular application. Specific examples thereof include, but are not limited to, urethane resins, polyester resins, acrylic resins, vinyl acetate resins, styrene resins, butadiene resins, styrene-butadiene resins, vinyl chloride resins, acrylic styrene resins, and acrylic silicone resins.

Each of these can be used alone or in combination with others.

The shape of the resin is not particularly limited and can be suitably selected to suit to a particular application. The resin may have a fixed shape or an irregular shape. Among these, the resin preferably has a fixed shape. When the resin has a fixed shape, the resin is preferably spherical. When the resin is spherical, the resin is preferably a particle.

The resin particles may be dispersed in water serving as a dispersion medium to prepare a resin emulsion. The ink can be obtained by mixing the resin emulsion with other materials such as a pigment and an organic solvent.

The volume average particle diameter of the resin particles is not particularly limited and can be suitably selected to suit to a particular application, but is preferably 10 nm or more to 1,000 nm or less, and more preferably 10 nm or more to 200 nm or less, and particularly preferably 10 nm or more to 100 nm or less, for desirable fixability and high image hardness.

A method for measuring the volume average particle diameter of the resin particles is not particularly limited and can be suitably selected to suit to a particular application. For example, the volume average particle diameter can be measured using a particle size analyzer (NANOTRAC WAVE UT151 manufactured by MicrotracBEL Corp.).

The proportion of the resin in the ink is not particularly limited and can be suitably selected to suit to a particular application, but is preferably 1% or more by mass to 30% or less by mass, and more preferably 5% or more by mass to 20% or less by mass from the viewpoint of fixability and storage stability of the ink.

Preferably, the particle diameter of the solid content in the ink is not particularly limited and can be suitably selected to suit to a particular application. From the viewpoint of improving discharge stability and image quality (e.g., image density), the maximum frequency particle diameter is preferably 20 nm or more to 1,000 nm or less and more preferably 20 nm or more to 150 nm or less based on the number of solid contents. The solid contents include resin particles and pigment particles.

The particle diameter of the solid content in the ink can be measured using, for example, a particle size analyzer (NANOTRAC WAVE UT151 manufactured by MicrotracBEL Corp.).

### Glycerin (B)

The proportion of the glycerin (B) in the ink is not particularly limited and can be suitably selected to suit to a particular application, but is preferably 5% or more by mass to 25% or less by mass.

When the proportion of the glycerin (B) in the ink is 5% or more by mass, the discharge stability is improved, which is preferable. When the proportion of the glycerin (B) in the ink is 25% or less by mass, the image robustness is improved, which is preferable.

As the glycerin (B), an appropriately synthesized one may be used, or a commercially available product may be used. Specific examples of the commercially available product of the glycerin (B) include, but are not limited to, glycerin (manufactured by FUJIFILM Wako Pure Chemical Corporation) as a trade name.

### Other Components (B)

The other components (B) are not particularly limited and can be suitably selected to suit to a particular application. Specific examples thereof include, but are not limited to, surfactants, defoamers, antiseptic antifungal agents, corrosion inhibitors, and pH adjusters.

A surfactant, a defoamer, an antiseptic antifungal agent, a corrosion inhibitor, and a pH adjuster are not particularly limited and can be suitably selected to suit to a particular application. For example, those described in the section of the pretreatment liquid may be used.

Specific examples of a qualitative method and a quantitative method for the organic solvent, the resin, the other components (B), and the like, contained in the ink include, but are not limited to, GC-MS. Specific examples of a measurement apparatus for GC-MS include, but are not limited to, GCMS-QP2020NX (manufactured by Shimadzu Corporation).

The water contained in the ink can be measured by a general method such as quantification of volatile components by GC-MS or mass change by TG-DTA.

The physical properties of the ink are not particularly limited and can be suitably selected to suit to a particular application. As an example, preferred viscosity, surface tension, and pH of the ink are described below.

The viscosity of the ink at 25° C. is preferably 5 mPa·s or more to 30 mPa·s or less, more preferably 5 mPa·s or more to 25 mPa·s or less from the viewpoint of improvements in the printing density and the character quality and the desirable discharge property. Here, the viscosity can be measured using, for example, a rotational viscometer (RE85L manufactured by Toki Sangyo Co., Ltd.). Measurement can be performed under the measurement conditions of 25° C., the use of a standard cone rotor (1°34′×R24), a sample liquid volume of 1.2 mL, a rotation speed of 50 rpm, and three minutes.

The surface tension of the ink is preferably 35 mN/m or less and more preferably 32 mN/m or less at 25° C. from the viewpoint that the ink is suitably leveled on a low-absorbent medium and the drying time of the ink is shortened.

The pH of the ink is preferably from 7 to 12, more preferably from 8 to 11, from the viewpoint of preventing corrosion of metal materials in contact with the ink.

### Posttreatment Liquid

The posttreatment liquid is not particularly limited as long as a transparent layer can be formed. The posttreatment liquid may be prepared by mixing an organic solvent, water, a resin, a surfactant, a defoamer, a pH adjuster, an antiseptic antifungal agent, a corrosion inhibitor, etc. selected as appropriate. As these components, the same components as those described in the section of the ink set described above can be used, and thus redundant description thereof will be omitted.

The posttreatment liquid may be applied to the entire region of the recording region formed on the low-absorbent medium, or may be applied only to the region where the ink image is formed.

The ink set according to the present embodiment is an ink set for forming images on a low-absorbent medium by inkjet discharge using an inkjet head of a line head type.

### Low-Absorbent Medium

In the present specification, “low absorbency” refers to low water permeability, absorbency, and/or adsorption. The low-absorbent medium also includes a base material that has a large number of cavities inside but is not open to the outside. More quantitatively, the low-absorbent medium refers to a medium in which the amount of pure water transferred to the recording medium during a contact time of 100 ms measured by a dynamic scanning absorptometer is 2 mL/m² or more to 35 mL/m² or less.

Specific examples of the low-absorbent medium include, but are not limited to, coated paper and slightly coated paper.

As the low-absorbent medium, a commercially available product may be used. Specific examples of the commercially available product of the low-absorbent medium include, but are not limited to, OK TopKote+ (manufactured by Oji Paper Co., Ltd.) as a trade name.

### Inkjet Head

The inkjet head of a line head type according to the present embodiment refers to an inkjet head in which the arrangement direction of the nozzles included in the inkjet head and the conveying direction of the low-absorbent medium are orthogonal to each other.

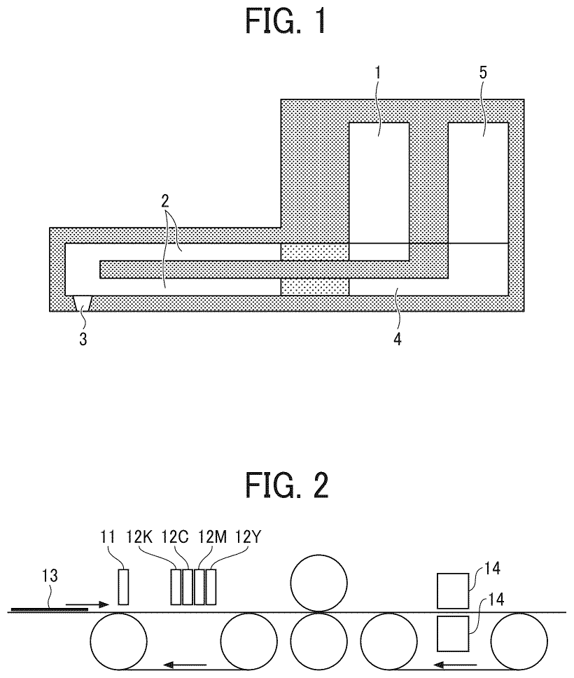

The inkjet head preferably includes a circulation mechanism of an individual liquid chamber. Specific examples of the circulation mechanism of the individual liquid chamber include, but are not limited to, a mechanism in which a part of the ink filled in a pressurizing liquid chamber 2 from a common liquid chamber 1 is discharged by a nozzle 3 and the remaining ink passes through a collection flow path 4 and returns to a circulation liquid chamber 5, as illustrated in FIG. 1.

In the image obtained by inkjet discharge of the ink set according to the present embodiment onto a low-absorbent medium, the mass ratio (resin/pigment) of the resin to the pigment is 1.6 or more to 20 or less.

When the mass ratio (resin/pigment) of the resin to the pigment in the image is 1.6 or more, the adhesion to the medium is improved, and thus the image robustness is desirable. When the mass ratio (resin/pigment) of the resin to the pigment in the image is 20 or less, a decrease in the ratio of the pigment to the resin can be suppressed, and thus the image density is desirable.

A method for measuring the mass ratio (resin/pigment) of the resin to the pigment in the image is not particularly limited and can be suitably selected to suit to a particular application. For example, the mass ratio can be measured as follows.

The mass ratio (resin/pigment) of the resin to the pigment is calculated from thermogravimetric change (TG) data obtained by using a thermogravimetric measurement-differential thermal analyzer (trade name: THERMOPLUS, manufactured by Rigaku Corporation) with a solidified ink material obtained by scraping off and peeling off the obtained image with a razor. To be specific, data of a glass transition temperature Tg is obtained by heating the solidified ink material of about 15 mg to 500° C. at 10° C./min under a nitrogen atmosphere by using a thermogravimetric measurement-differential thermal analyzer.

The weight loss from 200° C. to 500° C. under a nitrogen atmosphere is defined as “resin amount (W_{R})”, and the residue is defined as “pigment amount (W_{P})”. The mass ratio (resin/pigment) of the resin to the pigment is determined from the following equation.

Mass ratio (resin/pigment) of resin to pigment=W_{R}/W_{P}

An organic compound having an isocyanate group is detected by pyrolysis GC-MS from an image obtained by inkjet discharge of the ink set according to the present embodiment onto a low-absorbent medium. In other words, the mass spectrum of the image detected by the pyrolysis GC-MS measurement preferably includes a spectrum that coincides with the mass spectrum of the organic compound having an isocyanate group.

With this configuration, the structure of the resin becomes flexible, and thus it is possible to obtain an ink set that can print an image having desirable robustness and also has desirable discharge stability.

A method for detecting the organic compound having an isocyanate group is not particularly limited and can be suitably selected to suit to a particular application. For example, the organic compound having an isocyanate group can be detected by using a pyrolysis gas chromatography-mass spectrometer used for pyrolysis GC-MS with a solidified ink material obtained by scraping off and peeling off the obtained image with a razor.

Specific examples of the pyrolysis gas chromatography-mass spectrometer include, but are not limited to, a series of apparatuses in which a thermal analyzer (apparatus name: Py-3030D, manufactured by Frontier Laboratories Ltd.), a GC analyzer (apparatus name: 7890B, manufactured by Agilent Technologies, Inc), and an MS analyzer (apparatus name: Q1500, manufactured by JEOL Ltd.) are directly connected.

The glass transition temperature of the solidified ink material in the image having a black (“Bk”) image density of 1.3 or more as measured by a differential scanning calorimeter is preferably 30° C. or more to 170° C. or less, more preferably 30° C. or more to 100° C. or less.

When the glass transition temperature of the solidified ink material in the image having a Bk image density of 1.3 or more as measured by the differential scanning calorimeter is 30° C. or more, the adhesion to the head is suppressed, and thus the discharge stability is desirable. When the glass transition temperature of the solidified ink material in the image having a Bk image density of 1.3 or more as measured by the differential scanning calorimetry is 170° C. or less, the adhesion to the medium is improved due to the fusion of the ink at the time of heating, and thus the image robustness is desirable.

The image density is measured using a differential scanning calorimeter. As the differential scanning calorimeter, for example, a differential scanning calorimeter (DSC system Q-2000, manufactured by TA Instruments) can be used.

The method for measuring the glass transition temperature of the solidified ink material is not particularly limited and can be suitably selected to suit to a particular application. For example, the glass transition temperature can be measured as follows.

An ink powder obtained by shaving off an image with a shaver is placed in an aluminum sample vessel in an amount of about 5.0 mg, and the measurement is performed on the following temperature increase conditions (1) to (4) under a nitrogen atmosphere. The glass transition temperature Tg of the ink powder is determined from the DSC curve during the second temperature increase.
(1) Held for 5 minutes after cooling to −80° C.
(2) Increase temperature to 160° C. at 10° C./min
(3) Held for 5 minutes after cooling to −80° C.
(4) Increase temperature to 200° C. at 10° C./min

### (Inkjet Recording Method and Inkjet Recording Apparatus)

An inkjet recording method according to the present embodiment is an inkjet recording method for recording an image on a low-absorbent medium using an ink set and includes a pretreatment liquid applying step and an ink applying step and may include a drying step and other steps as appropriate.

An inkjet recording apparatus according to the present embodiment includes a pretreatment liquid applying unit and an ink applying unit and may include a drying unit and other units as appropriate.

FIG. 2 is a schematic diagram illustrating an example of a structure of the inkjet recording apparatus according to the present embodiment. The inkjet recording apparatus according to the present embodiment is a single-pass type inkjet recording apparatus that can perform the pretreatment liquid applying step, the ink applying step, and the drying step in a single in-line conveyance of a recording medium 13. In the inkjet recording apparatus, on-demand type heads 11 and 12 of a piezoelectric system having a liquid circulation mechanism in the head are mounted as inkjet heads. Each pretreatment liquid is accommodated in the on-demand type head 11, and each ink is accommodated in the on-demand type heads 12 (including 12K, 12C, 12M, and 12Y).

### Pretreatment Liquid Applying Step and Pretreatment Liquid Applying Unit

The pretreatment liquid applying step is a step of applying a pretreatment liquid to a low-absorbent medium.

The pretreatment liquid applying unit is a unit that applies a pretreatment liquid to a low-absorbent medium.

The pretreatment liquid applying step can be preferably performed by the pretreatment liquid applying unit.

Since the pretreatment liquid and the low-absorbent medium are the same as those described in the section of the ink set described above, redundant description will be omitted.

The pretreatment liquid applying unit is an inkjet head of a line head type.

### Ink Applying Step and Ink Applying Unit

The ink applying step is a step of applying an ink to at least a part of the region to which the pretreatment liquid has been applied.

The ink applying unit is a unit that applies an ink to at least a part of the region to which the pretreatment liquid has been applied.

The ink applying step can be preferably performed by the ink applying unit.

Since the ink is the same as that described in the section of the ink set described above, redundant description will be omitted.

The ink applying unit is an inkjet head of a line head type.

### Drying Step and Drying Unit

The drying step is a step of drying the image by applying energy to the ink applied in the ink applying step.

The drying unit is a unit that dries the image by applying energy to the ink applied in the ink applying step.

The drying step can be preferably performed by the drying unit.

The energy in the drying step and a drying unit 14 is not particularly limited and can be suitably selected to suit to a particular application, but is preferably at least one selected from group consisting of heat, infrared rays, and ultraviolet rays from the viewpoint of the desirable drying efficiency of the low-absorbent medium.

In the drying step, the energy may be applied to the print surface of the low-absorbent medium, the rear surface of the low-absorbent medium, or both surfaces of the low-absorbent medium.

The drying step can be performed before printing, during printing, after printing, or the like.

### Other Steps and Other Units

The other steps are not particularly limited and can be suitably selected according to the objective. Specific examples thereof include, but are not limited to, a posttreatment liquid applying step.

The other units are not particularly limited and can be suitably selected according to the objective. Specific examples thereof include, but are not limited to, a posttreatment liquid applying unit.

### Posttreatment Liquid Applying Step and Posttreatment Liquid Applying Unit

The posttreatment liquid applying step is a step of applying a posttreatment liquid to the low-absorbent medium to which the ink has been applied.

The posttreatment liquid applying unit is a unit that applies a posttreatment liquid to the low-absorbent medium to which the ink has been applied.

The posttreatment liquid applying step can be preferably performed by the posttreatment liquid applying unit.

As an aspect of the posttreatment liquid applying unit, as in the case of the inks of black (K), cyan (C), magenta (M), yellow (Y), and the like, there is an aspect in which a liquid accommodation unit having a posttreatment liquid and a liquid discharge head are added and the posttreatment liquid is discharged by an inkjet recording method.

Another aspect of the posttreatment liquid applying unit is not particularly limited and can be suitably selected to suit to a particular application. For example, there is an aspect in which a posttreatment device using a blade coating method, a roll coating method, or a spray coating method is provided.

The inkjet recording apparatus according to the present embodiment can include not only a head portion that discharges the ink set but also units related to feeding, conveying, and ejection of a recording medium.

The inkjet recording method and the inkjet recording apparatus according to the present embodiment are not limited to those in which a significant image such as a character or a figure is visualized by the ink set. For example, formation of patterns like geometric design and three-dimensional images are also included.

The inkjet recording apparatus also includes a line type apparatus in which the discharge head is not moved, unless otherwise specified.

In the present specification, the terms “image formation”, “recording”, “printing”, and the like are used synonymously.

In the present specification, the terms “recording medium”, “media”, and “non-printed matter” are used synonymously.

The recorded matter according to the present embodiment includes an image formed on a low-absorbent medium using an ink set. The recorded matter may be produced by an inkjet recording apparatus and an inkjet recording method.

### EXAMPLES

Hereinafter, the present embodiment will be described in detail with reference to the examples and comparative examples, but the present embodiment is not limited to these examples. In the following examples and comparative examples, “part(s)” means “part(s) by mass” and “%” means “% by mass” unless otherwise specified.

### Preparation of Magenta-Pigment-Containing Polymer Microparticle Dispersion Liquid

### Preparation Example of Polymer Solution A

A 1 L flask including a mechanical stirrer, a thermometer, a nitrogen inlet tube, a reflux tube, and a dropping funnel was thoroughly replaced with nitrogen gas, and then the following materials were mixed and heated to 65° C.
Styrene: 11.2 g
Acrylic acid: 2.8 g
Lauryl methacrylate: 12.0 g
Polyethylene glycol methacrylate: 4.0 g
Styrene Macromer: 4.0 g
Mercaptoethanol: 0.4 g

Subsequently, a mixed solution of the following materials was dropped to the flask over a period of 2.5 hours.
Styrene: 100.8 g
Acrylic acid: 25.2 g
Lauryl methacrylate: 108.0 g
Polyethylene glycol methacrylate: 36.0 g
Hydroxylethyl methacrylate: 60.0 g
Styrene Macromer: 36.0 g
Mercaptoethanol: 3.6 g
Azobismethylvaleronitrile: 2.4 g
Methyl ethyl ketone: 18 g

Next, another mixture liquid containing 0.8 g of azobis methylvaleronitrile and 18 g of methyl ethyl ketone was further dropped in the flask over a period of 0.5 hours. After stirring at 65° C. for a period of 1 hour, 0.8 g of azobismethylvaleronitrile was added and further stirred for a period of 1 hour. After completion of the reaction, 364 g of methyl ethyl ketone was added to the flask. Thus, 800 g of a polymer solution A having a concentration of 50% by mass was obtained.

Next, the following materials were sufficiently stirred and then kneaded with a roll mill to obtain a paste.
Polymer solution A: 28 g
C.I. Pigment Red 122:42 g
1 mol/L aqueous potassium hydroxide: 13.6 g
Methyl ethyl ketone: 20 g
Water: 13.6 g

After the resulting paste was poured in 200 g of pure water and sufficiently stirred, methyl ethyl ketone and water were evaporated therefrom using an evaporator. The resulting dispersion liquid was subjected to pressure filtration using a polyvinylidene fluoride membrane filter having an average pore diameter of 5.0 μm to remove coarse particles. Thus, a magenta-pigment-containing polymer microparticle dispersion liquid containing 15% by mass of the pigment and 20% by mass of solid contents was prepared.

The average particle diameter (D50) of the polymer microparticle in the obtained magenta-pigment-containing polymer microparticle dispersion liquid was 127 nm. The average particle diameter (D50) was measured with a particle size distribution analyzer (NANOTRAC UPA-EX150 available from Nikkiso Co., Ltd.).

Preparation of Cyan-Pigment-Containing Polymer Microparticle Dispersion Liquid A cyan-pigment-containing polymer microparticle dispersion liquid was prepared in the same manner as in the above section of preparation of the magenta-pigment-containing polymer microparticle dispersion liquid except that the C.I. Pigment Red 122 was changed to a phthalocyanine pigment (C.I. Pigment Blue 15:3).

The average particle diameter (D50) of the polymer microparticles in the obtained cyan-pigment-containing polymer microparticle dispersion liquid was 93 nm.

### Preparation of Yellow-Pigment-Containing Polymer Microparticle Dispersion Liquid

A yellow-pigment-containing polymer microparticle dispersion liquid was prepared in the same manner as in the above section of preparation of the magenta-pigment-containing polymer microparticle dispersion liquid except that C.I. Pigment Red 122 was changed to a monoazo yellow pigment (C.I. Pigment Yellow 74).

The average particle diameter (D50) of the polymer microparticles in the obtained yellow-pigment-containing polymer microparticle dispersion liquid was 76 nm.

### Preparation of Black-Pigment-Containing Polymer Microparticle Dispersion Liquid

A black-pigment-containing polymer microparticle dispersion liquid was prepared in the same manner as in the above section of preparation of the magenta-pigment-containing polymer microparticle dispersion liquid except that C.I. Pigment Red 122 was changed to carbon black (manufactured by Degussa, FW100).

The average particle diameter (D50) of the polymer microparticles in the obtained black-pigment-containing polymer microparticle dispersion liquid was 104 nm.

### Preparation of Color Ink

The materials illustrated in Tables 1 and 2 were mixed and stirred for a period of 60 minutes so as to have the proportions illustrated in Tables 1 and 2. The resulting mixture was subjected to pressure filtration using a polyvinylidene fluoride membrane filter having an average pore diameter of 1.5 μm to remove coarse particles and foreign substances. Thus, each ink was prepared.

The details of the materials used in the preparation of each ink are as follows.

### Resin

SUPERFLEX 150HS (Tg: 32° C., manufactured by DKS Co., Ltd.)
SUPERFLEX 210 (Tg: 41° C., manufactured by DKS Co., Ltd.)
SUPERFLEX 170 (Tg: 75° C., manufactured by DKS Co., Ltd.)
SUPERFLEX 130 (Tg: 101° C., manufactured by DKS Co., Ltd.)
SUPERFLEX 460 (Tg: −21° C., manufactured by DKS Co., Ltd.)
MOWINYL 5450 (Tg: 54° C., manufactured by Japan Coating Resin Corporation)

### Organic Solvent

Glycerin (manufactured by FUJIFILM Wako Pure Chemical Corporation)
Propylene glycol (manufactured by FUJIFILM Wako Pure Chemical Corporation)
1,2-hexanediol (manufactured by FUJIFILM Wako Pure Chemical Corporation)

### Surfactant

ACETYLENOL E-1000 (manufactured by Kawaken Fine Chemicals Co., Ltd.)
SURFYNOL AD-01 (manufactured by Nissin Chemical Industry Co., Ltd.)

### Preservative

PROXEL GXL (manufactured by Avecia Ltd.)

The viscosity of each ink at 25° C. was measured using a viscosimeter (RE-550L, manufactured by Toki Sangyo Co., Ltd.). Tables 1 and 2 indicate the results.

TABLE 1

| INK No. | | | 1 | 2 | 3 | 4 | 5 | 6 |
|---|---|---|---|---|---|---|---|---|
| PIGMENT | BLACK PIGMENT DISPERSION | | 3.0 | 3.0 | 3.0 | 3.0 | 3.0 | 3.0 |
| | CYAN PIGMENT DISPERSION | | — | — | — | — | — | — |
| | MAGENTA PIGMENT DISPERSION | | — | — | — | — | — | — |
| | YELLOW PIGMENT DISPERSION | | — | — | — | — | — | — |
| RESIN | SUPERFLEX 170 | | 10.0 | — | — | — | — | 10.0 |
| | (Tg: 75° C., | | | | | | | |
| | SOLID CONTENT: 30) | | | | | | | |
| | SUPERFLEX 130 | | — | 10.0 | — | — | — | — |
| | (Tg: 101° C., | | | | | | | |
| | SOLID CONTENT: 35) | | | | | | | |
| | SUPERFLEX 460 | | — | — | 10.0 | — | — | — |
| | (Tg: −21° C.) | | | | | | | |
| | SUPERFLEX 150HS | | — | — | — | 10.0 | — | — |
| | (Tg: 32° C., | | | | | | | |
| | SOLID CONTENT: 38) | | | | | | | |
| | SUPERFLEX 210 | | — | — | — | — | 10.0 | — |
| | (Tg: 41° C., | | | | | | | |
| | SOLID CONTENT: 35) | | | | | | | |
| | MOWINYL 5450 | | — | — | — | — | — | — |
| | (Tg: 54° C.) | | | | | | | |
| GLYCERIN (B) | | | 10.0 | 10.0 | 10.0 | 10.0 | 10.0 | 3.0 |
| SOLVENT | | 1,2-HEXANEDIOL | 5.0 | 5.0 | 5.0 | 5.0 | 5.0 | 5.0 |
| | | PROPYLENE GLYCOL | — | — | — | — | — | — |
| SURFACTANT | NON- | ACETYLENOL E-1000 | — | — | — | — | — | — |
| | IONIC | AD-01 | — | — | — | — | — | — |

| | | | | | | | |
|---|---|---|---|---|---|---|---|
| PRESERVATIVE | PROXEL GXL | 0.2 | 0.2 | 0.2 | 0.2 | 0.2 | 0.2 |

| | | | | | | |
|---|---|---|---|---|---|---|
| ION-EXCHANGED WATER | REMNANT | REMNANT | REMNANT | REMNANT | REMNANT | REMNANT |
| VISCOSITY | 4.5 | 4.6 | 4.2 | 4.5 | 4.6 | 3.5 |
| MASS RATIO (RESIN/PIGMENT) | 3.4 | 3.4 | 3.4 | 3.4 | 3.4 | 3.4 |

TABLE 2

| INK No. | | | 7 | 8 | 9 | 10 | 11 | 12 | 13 |
|---|---|---|---|---|---|---|---|---|---|
| PIGMENT | BLACK PIGMENT DISPERSION | | 3.0 | — | — | — | 3.0 | 3.0 | 0.9 |
| | CYAN PIGMENT DISPERSION | | — | 3.0 | — | — | — | — | — |
| | MAGENTA PIGMENT DISPERSION | | — | — | 4.0 | — | — | — | — |
| | YELLOW PIGMENT DISPERSION | | — | — | — | 4.0 | — | — | — |
| RESIN | SUPERFLEX 170 | | 10.0 | 10.0 | 10.0 | — | — | — | 20.0 |
| | (Tg: 75° C., | | | | | | | | |
| | SOLID CONTENT: 30) | | | | | | | | |
| | SUPERFLEX 130 | | — | — | — | 10.0 | — | — | — |
| | (Tg: 101° C., | | | | | | | | |
| | SOLID CONTENT: 35) | | | | | | | | |
| | SUPERFLEX 460 | | — | — | — | — | 3.0 | — | — |
| | (Tg: −21° C.) | | | | | | | | |
| | SUPERFLEX 150HS | | — | — | — | — | — | — | — |
| | (Tg: 32° C., | | | | | | | | |
| | SOLID CONTENT: 38) | | | | | | | | |
| | SUPERFLEX 210 | | — | — | — | — | — | — | — |
| | (Tg: 41° C., | | | | | | | | |
| | SOLID CONTENT: 35) | | | | | | | | |
| | MOWINYL 5450 | | — | — | — | — | — | 4.5 | — |
| | (Tg: 54° C.) | | | | | | | | |
| GLYCERIN (B) | | | 30.0 | 10.0 | 10.0 | 10.0 | 10.0 | 3.0 | 10.0 |
| SOLVENT | | 1,2-HEXANEDIOL | 5.0 | 5.0 | — | — | 5.0 | 6.0 | 5.0 |
| | | PROPYLENE GLYCOL | — | — | 5.0 | 5.0 | — | — | — |
| SURFACTANT | NON- | ACETYLENOL E-1000 | — | 0.5 | — | — | 0.5 | 0.5 | 0.5 |
| | IONIC | AD-01 | — | — | 0.5 | 0.5 | — | — | — |

| | | | | | | | | |
|---|---|---|---|---|---|---|---|---|
| PRESERVATIVE | PROXEL GXL | 0.2 | 0.2 | 0.2 | 0.2 | 0.2 | 0.2 | 0.2 |

| | | | | | | | |
|---|---|---|---|---|---|---|---|
| ION-EXCHANGED WATER | REM- | REM- | REM- | REM- | REM- | REM- | REM- |
| | NANT | NANT | NANT | NANT | NANT | NANT | NANT |
| VISCOSITY | 6.0 | 4.6 | 4.5 | 4.5 | 4.0 | 4.2 | 5.0 |
| MASS RATIO (RESIN/PIGMENT) | 3.4 | 3.4 | 2.6 | 2.5 | 1.0 | 1.5 | 22.2 |

### Preparation of Pretreatment Liquid

The materials illustrated in Tables 3 and 4 were sufficiently mixed and stirred so as to have the proportions illustrated in Tables 3 and 4. Subsequently, the obtained mixture was filtered through #200 mesh of nylon mesh to obtain each pretreatment liquid.

The details of the materials used for the preparation of each pretreatment liquid are as follows.

### Flocculant

Magnesium sulfate (manufactured by FUJIFILM Wako Pure Chemical Corporation)
Calcium nitrate tetrahydrate (manufactured by FUJIFILM Wako Pure Chemical Corporation)
Sodium acetate (manufactured by Fujifilm Wako Pure Chemical Corporation) Organic Solvent
Glycerin (manufactured by FUJIFILM Wako Pure Chemical Corporation)
Propylene glycol (manufactured by FUJIFILM Wako Pure Chemical Corporation)
1,2-hexanediol (manufactured by FUJIFILM Wako Pure Chemical Corporation)

### Surfactant

35% N,N-dimethylalkylamine-N-oxide solution (manufactured by FUJIFILM Wako Pure Chemical Corporation)
NIKKOL AM-3130N (cocamidopropyl betaine, Nikko Chemicals Co., Ltd.)
ACETYLENOL E-1000 (manufactured by Kawaken Fine Chemicals Co., Ltd.)
SURFYNOL AD-01 (manufactured by Nissin Chemical Industry Co., Ltd.)

### Preservative

PROXEL GXL (manufactured by Avecia Ltd.)

The viscosity of each pretreatment liquid at 25° C. was measured using a viscosimeter (RE-550L, manufactured by Toki Sangyo Co., Ltd.). Tables 3 and 4 indicate the results.

TABLE 3

| PRETREATMENT LIQUID No. | | | 1 | 2 | 3 | 4 | 5 |
|---|---|---|---|---|---|---|---|
| INORGANIC | MAGNESIUM SULFATE | | 10.0 | — | 20.0 | 10.0 | 10.0 |
| COMPOUND | (pH: 4.0 TO 6.0) | | | | | | |
| | CALCIUM NITRATE | | — | 10.0 | — | — | — |
| | (pH: 5.0 TO 8.0) | | | | | | |
| | SODIUM ACETATE | | — | — | — | — | — |
| | (pH: 9.0) | | | | | | |
| GLYCERIN (A) | | | 15.0 | 15.0 | 15.0 | 4.5 | 20.0 |
| SURFACTANT | AMPHOLYTIC | N,N- | 0.2 | 0.2 | 0.2 | 0.2 | 0.2 |
| | | DIMETHYLDODECYLAMINE- | | | | | |
| | | N-OXIDE | | | | | |
| | | COCAMIDOPROPYL BETAINE | — | — | — | — | — |
| | NON-IONIC | ACETYLENOL E-1000 | 0.3 | 0.3 | 0.3 | 0.3 | 0.3 |
| | | SURFYNOL AD-01 | — | — | — | — | — |

| | | | | | | |
|---|---|---|---|---|---|---|
| SOLVENT | 1,2-HEXANEDIOL | — | — | — | — | — |
| | PROPYLENE GLYCOL | — | — | — | — | — |
| PRESERVATIVE | PROXEL GXL | 0.2 | 0.2 | 0.2 | 0.2 | 0.2 |

| | | | | | |
|---|---|---|---|---|---|
| ION-EXCHANGED WATER | REMNANT | REMNANT | REMNANT | REMNANT | REMNANT |
| VISCOSITY | 3.3 | 3.4 | 4.2 | 2.0 | 3.5 |

TABLE 4

| PRETREATMENT LIQUID No. | | | 6 | 7 | 8 | 9 | 10 | 11 |
|---|---|---|---|---|---|---|---|---|
| INORGANIC | MAGNESIUM SULFATE | | 10.0 | 10.0 | 10.0 | — | — | — |
| COMPOUND | (pH: 4.0 TO 6.0) | | | | | | | |
| | CALCIUM NITRATE | | — | — | — | — | — | — |
| | (pH: 5.0 TO 8.0) | | | | | | | |
| | SODIUM ACETATE | | — | — | — | — | 10.0 | 20.0 |
| | (Ph: 9.0) | | | | | | | |
| GLYCERIN (A) | | | 15.0 | 15.0 | 15.0 | 15.0 | — | — |
| SURFACTANT | AMPHOLYTIC | N,N- | — | — | 0.2 | 0.2 | — | — |
| | | DIMETHYLDODECYLAMINE- | | | | | | |
| | | N-OXIDE | | | | | | |
| | | COCAMIDOPROPYL BETAINE | 0.2 | — | — | — | — | — |
| | NON-IONIC | ACETYLENOL E-1000 | 0.3 | 0.5 | — | 0.3 | 0.5 | — |
| | | SURFYNOL AD-01 | — | — | 0.3 | — | — | 0.5 |

| | | | | | | | |
|---|---|---|---|---|---|---|---|
| SOLVENT | 1,2-HEXANEDIOL | — | — | — | — | — | 5.0 |
| | PROPYLENE GLYCOL | — | — | — | — | 10.0 | 5.0 |
| PRESERVATIVE | PROXEL GXL | 0.2 | 0.2 | 0.2 | 0.2 | 0.2 | 0.2 |

| | | | | | | |
|---|---|---|---|---|---|---|
| ION-EXCHANGED WATER | REM- | REM- | REM- | REM- | REM- | REM- |
| | NANT | NANT | NANT | NANT | NANT | NANT |
| VISCOSITY | 3.3 | 3.3 | 3.2 | 1.4 | 1.0 | 1.2 |

### Examples 1 to 17 and Comparative Examples 1 to 6

As illustrated in Tables 5 and 6, printing of an image was performed by combining each pretreatment liquid and each ink. The inkjet recording apparatus illustrated in FIG. 2 was used for printing in each example and each comparative example. The printing conditions of the pretreatment liquid and the ink for printing were as follows: 2 mm of a head gap, 4 μL of a discharge amount per droplet, 1200 dpi×1200 dpi, and 1.2 mg/cm² of an adhesion amount. Subsequent to the printing of the ink, the ink was dried by the drying unit 4 mounted on the inkjet recording apparatus. The time from the printing of the ink to the drying, that is, the time from the discharge of the ink in the ink applying step to the drying step was adjusted to be 5 seconds by changing the conveying speed of the recording medium 3 between the on-demand type head 2 and the drying unit 4.

OK TopKote+ (127.9 gsm) (manufactured by Oji Paper Co., Ltd.) was used as the low-absorbent medium in each example and each comparative example.

### Method for Detecting Organic Compound Having Isocyanate Group

A solidified ink material obtained by scraping off and peeling off the image obtained in each example and each comparative example with a razor was analyzed with a pyrolysis gas chromatography-mass spectrometer used for pyrolysis GC-MS to detect an organic compound having an isocyanate group. The case where the organic compound having an isocyanate group was detected is described as “∘”, and the case where the organic compound having an isocyanate group was not detected is described as “x”. Tables 5 and 6 indicate the results.

### Measurement of Glass Transition Temperature of Solidified Ink Material

An ink powder obtained by shaving off the image obtained in each example and each comparative example with a shaver was placed in an aluminum sample vessel in an amount of about 5.0 mg, and the measurement was performed on the following temperature increase conditions (1) to (4) under a nitrogen atmosphere. The glass transition temperature Tg of the ink powder was determined from the DSC curve during the second temperature increase. Tables 5 and 6 indicates the results.
(1) Held for 5 minutes after cooling to −80° C.
(2) Increase temperature to 160° C. at 10° C./min
(3) Held for 5 minutes after cooling to −80° C.
(4) Increase temperature to 200° C. at 10° C./min

The image obtained in each example and each comparative example was evaluated for image density and image robustness. The discharge stability of the ink set used in each example and each comparative example was evaluated. C indicates cyan, M indicates magenta, Y indicates yellow, and K indicates black. Tables 5 and 6 indicate the results.

### Evaluation of Image Density

A chart was printed, on which a 64-point character “▪” was printed, and the color of the “▪” portion of the printed surface was measured with x-rite eXact™ and evaluated according to the following evaluation criteria.

### Evaluation Criteria

A: K is 1.20 or more, C is 1.0 or more, Mis 1.0 or more, and Y is 0.80 or more
B: K is 1.10 or more to less than 1.20, C is 0.90 or more to less than 1.0, Mis 0.90 or more to less than 1.0, and Y is 0.70 or more to less than 0.80
C: K is less than 1.10, C is less than 0.90, M is less than 0.90, and Y is less than 0.70

### Evaluation of Robustness (Rubbing Resistance)

A solid image of 5 cm×20 cm was prepared. After printing and drying, the rubbing resistance of C, M, Y, and K was evaluated. A crockmeter to which a cotton cloth was attached was reciprocated five times on each image, and evaluation was performed according to the following evaluation criteria based on the degree of coloring of the cotton cloth.

### Evaluation Criteria

A: not colored
B: hardly colored
C: slightly colored
D: darkly colored

### Evaluation of Discharge Stability

A chart in which A4 size paper was filled with a solid image was continuously printed on 100 sheets, and evaluation was performed according to the following evaluation criteria based on the discharge disturbance of each nozzle after printing.

### Evaluation Criteria

A: no discharge disturbance
B: presence of discharge disturbance of less than 10% with respect to all nozzles
C: presence of discharge disturbance of 10% or more with respect to all nozzles or presence of nozzle that does not discharge

TABLE 5

| | | | ORGANIC | GLASS | | | |
|---|---|---|---|---|---|---|---|
| | | | COMPOUND | TRANSITION | | | |
| | | | HAVING | TEMPERATURE | | | |
| | | | ISOCYANATE | (° C.) OF | | | |
| | PRETREATMENT | INK | GROUP | SOLIDIFIED INK | IMAGE | IMAGE | DISCHARGE |
| | LIQUID No. | No. | DETECTED | MATERIAL | DENSITY | ROBUSTNESS | STABILITY |
| EXAMPLE 1 | 1 | 1 | ∘ | 75 | A | A | A |
| EXAMPLE 2 | 1 | 2 | ∘ | 101 | A | B | A |
| EXAMPLE 3 | 1 | 3 | ∘ | −20 | A | A | B |
| EXAMPLE 4 | 1 | 4 | ∘ | 32 | A | B | A |
| EXAMPLE 5 | 1 | 5 | ∘ | 41 | A | B | A |
| EXAMPLE 6 | 1 | 6 | ∘ | 75 | A | A | B |
| EXAMPLE 7 | 1 | 7 | ∘ | 75 | A | B | A |
| EXAMPLE 8 | 1 | 8 | ∘ | — | A | A | A |
| EXAMPLE 9 | 1 | 9 | ∘ | — | A | A | A |
| EXAMPLE 10 | 1 | 10 | ∘ | — | A | A | A |
| EXAMPLE 11 | 2 | 1 | ∘ | 75 | A | A | A |
| EXAMPLE 12 | 3 | 1 | ∘ | 75 | B | A | A |
| EXAMPLE 13 | 4 | 1 | ∘ | 75 | A | A | B |
| EXAMPLE 14 | 5 | 1 | ∘ | 75 | A | B | A |
| EXAMPLE 15 | 6 | 1 | ∘ | 75 | A | A | B |
| EXAMPLE 16 | 7 | 1 | ∘ | 75 | A | A | B |
| EXAMPLE 17 | 8 | 1 | ∘ | 75 | A | A | A |

TABLE 6

| | | | ORGANIC | GLASS | | | |
|---|---|---|---|---|---|---|---|
| | | | COMPOUND | TRANSITION | | | |
| | | | HAVING | TEMPERATURE | | | |
| | | | ISOCYANATE | (° C.) OF | | | |
| | PRETREATMENT | INK | GROUP | SOLIDIFIED INK | IMAGE | IMAGE | DISCHARGE |
| | LIQUID No. | No. | DETECTED | MATERIAL | DENSITY | ROBUSTNESS | STABILITY |
| COMPARATIVE | 9 | 1 | ∘ | 75 | C | C | A |
| EXAMPLE 1 | | | | | | | |
| COMPARATIVE | 10 | 1 | ∘ | 75 | B | B | C |
| EXAMPLE 2 | | | | | | | |
| COMPARATIVE | 11 | 1 | ∘ | 75 | B | B | C |
| EXAMPLE 3 | | | | | | | |
| COMPARATIVE | 1 | 11 | ∘ | −20 | C | B | C |
| EXAMPLE 4 | | | | | | | |
| COMPARATIVE | 1 | 12 | x | 53 | B | C | C |
| EXAMPLE 5 | | | | | | | |
| COMPARATIVE | 1 | 13 | ∘ | 75 | C | B | C |
| EXAMPLE 6 | | | | | | | |

Aspects of the present embodiment include, for example, the following.

### Aspect 1

An ink set including:
a pretreatment liquid comprising an inorganic compound, glycerin (A), and a surfactant; and
an ink comprising a pigment, a resin, and glycerin (B),
in which an aqueous solution of the inorganic compound dissolved in water at 25° C. at a concentration of 5% by mass is 4 or more to 8 or less,
an image formed with the ink set on a low-absorbent medium by inkjet discharge using an inkjet head of a line head type has a mass ratio (resin/pigment) of the resin to the pigment of 1.6 or more to 20 or less, and
the image contains an organic compound having an isocyanate group as detected by pyrolysis gas chromatography-mass spectrometry (GC-MS).

### Aspect 2

The ink set according to Aspect 1, in which the surfactant is an ampholytic surfactant.

### Aspect 3

The ink set according to Aspect 1 or 2, in which the inorganic compound comprises at least one of magnesium sulfate or calcium nitrate.

### Aspect 4

The ink set according to any one of Aspects 1 to 3, in which the image has a black image density of 1.3 or more, and a solidified material of the ink in the image has a glass transition temperature of 30° C. or more to 170° C. or less as measured by a differential scanning calorimeter.

### Aspect 5

The ink set according to any one of Aspects 1 to 4, in which
a proportion of the glycerin (A) in the pretreatment liquid is 5% or more by mass to 15% or less by mass, and
a proportion of the glycerin (B) in the ink is 5% or more by mass to 25% or less by mass.

### Aspect 6

The ink set according to any one of Aspects 1 to 5, in which the pretreatment liquid has a viscosity at 25° C. of 4.0 mPa·s or more to 7.0 mPa·s or less.

### Aspect 7

The ink set according to any one of Aspects 1 to 6, wherein the inkjet head has a circulation mechanism of an individual liquid chamber.

### Aspect 8

The ink set according to any one of Aspects 1 to 7, wherein the low-absorbent medium is coated paper.

### Aspect 9

An inkjet recording method including:
applying the pretreatment liquid of the ink set according to any one of Aspects 1 to 8 to a low-absorbent medium; and
applying the ink of the ink set to at least a part of a region to which the pretreatment liquid has been applied to form an image.

### Aspect 10

The inkjet recording method according to Aspect 9, further including applying energy to the ink applied in the applying the ink to dry the image.

### Aspect 11

The inkjet recording method according to Aspect 10, in which the energy is at least one selected from group consisting of heat, infrared rays, and ultraviolet rays.

The ink set according to any one of Aspects 1 to 8 and the inkjet recording method according to any one of Aspects 9 to 11 can solve the problems in the related art and achieve the object of the present embodiment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An ink set comprising:
a pretreatment liquid comprising an inorganic compound, glycerin (A), and a surfactant; and
an ink comprising a pigment, a resin, and glycerin (B),
wherein an aqueous solution of the inorganic compound dissolved in water at 25° C. at a concentration of 5% by mass is 4 or more to 8 or less,
wherein an image formed with the ink set on a low-absorbent medium by inkjet discharge using an inkjet head of a line head type has a mass ratio of the resin to the pigment of 1.6 or more to 20 or less, and
the image contains an organic compound having an isocyanate group as detected by pyrolysis gas chromatography-mass spectrometry.

2. The ink set according to claim 1, wherein the surfactant is an ampholytic surfactant.

3. The ink set according to claim 1, wherein the inorganic compound comprises at least one of magnesium sulfate or calcium nitrate.

4. The ink set according to claim 1,
wherein the image has a black image density of 1.3 or more, and
wherein a solidified material of the ink in the image has a glass transition temperature of 30° C. or more to 170° C. or less as measured by a differential scanning calorimeter.

5. The ink set according to claim 1, wherein
a proportion of the glycerin (A) in the pretreatment liquid is 5% or more by mass to 15% or less by mass, and
a proportion of the glycerin (B) in the ink is 5% or more by mass to 25% or less by mass.

6. The ink set according to claim 1, wherein the pretreatment liquid has a viscosity at 25° C. of 4.0 mPa·s or more to 7.0 mPa·s or less.

7. The ink set according to claim 1, wherein the inkjet head has a circulation mechanism of an individual liquid chamber.

8. The ink set according to claim 1, wherein the low-absorbent medium is coated paper.

9. An inkjet recording method comprising:
applying the pretreatment liquid of the ink set according to claim 1 to a low-absorbent medium; and
applying the ink of the ink set to at least a part of a region to which the pretreatment liquid has been applied to form an image.

10. The inkjet recording method according to claim 9, further comprising:
applying energy to the ink applied in the applying the ink to dry the image.

11. The inkjet recording method according to claim 10, wherein the energy is at least one selected from group consisting of heat, infrared rays, and ultraviolet rays.
